(19) United States
(12) Patent Application Publication
(10) Pub. No.: US 2012/0227111 A1
(43) Pub. Date: Sep. 6, 2012

(54) Method and system of organizing credentials data online

(76) Inventor: James B. Blitch, III, Metairie, LA (US)

(21) Appl. No.: 12/932,632

(22) Filed: Mar. 2, 2011

(51) Int. Cl. G06F 21/24

(52) U.S. Cl. 726/26

(57) ABSTRACT

A system and method of disseminating information about an individual's achievements allows the individual to create a web portal within a social network web site and display the data about individual's credentials, awards, trophies and the like in a separate distinct modules. The system provides hyperlinks to the institutions that store authenticating data about the individual's achievements. When the web portal of the individual is linked via the Internet to the institution's database, a visitor to the web portal can connect to the institution's web site and verify the credentials posted on the web portal.

### BACKGROUND OF THE INVENTION

This invention relates to data processing, and more particularly to management of data between various sources.

Recently, social network services began proliferating on the Internet. The social network sites offer different types of services. Some sites are designed for connecting with personal friends, while other sites are more business-oriented. Each of the social network services typically requires a user to provide user-specific profile information. All of the sites require or store some amount of personal profile information, such as, for example, a personal summary statement, status, past experience, qualifications, interests, contact information, and the like.

Personal pages of the users often become boasting boards for the user's achievement. Anyone can publish personal information on the Web and list educational, athletic, scientific and other achievements about the user. To maintain the user's profile information within a social network, an individual logs into the web site supported by the network and updates her page. For example, a user can change her summary statement in the social network application numerous times with updates on job experience, publications, awards and other credentials.

It is important for users of the Web to have a means of evaluating the credibility of Internet information and sorting out dependable from undependable information. Determining the credibility of the user-posted information based on such clues as connection of the user to an educational, publishing, scientific or other organization without supporting evidence is time-consuming and unreliable. For instance, in case of employment, the prospective employer will have to send a formal inquiry to an educational institution with a specific request for information about the particular individual who claims to have graduated or attended that educational institution. The same may be true for confirming athletic, job-related or other types of credentials that need to be verified before a job seeker can be offered a job in a particular company. Similarly, some government job applicants undergo rigorous background checks before being allowed access to sensitive information. Such situations require definite authentication of all credentials listed on a prospective employee's page in a social networking web site.

The present invention contemplates provision of an interactive system that would allow the users of social networking web sites to create their profiles and form links to organizations and institutions that can authenticate and confirm the users' achievements.

### SUMMARY OF THE INVENTION

It is, therefore, an object of the present invention to provide a system and method of posting achievements and credentials data on a social network page that can be easily verified by a visitor to the page.

It is another object of the invention to provide a method and system of organizing credentials data on a social networking web site accessible by third-party users.

These and other objects of the invention are achieved through a provision of a social networking system of disseminating data about individual user's achievements in selected fields, such as academic, professional military, sport and other areas. The system comprises a computer, a display controlled by the computer, and networking hardware connecting the computer to the Internet. The computer is programmed so that the social networking system: is configurable to create a web portal adapted to display data about the individual user's achievements, connect to an authenticating database adapted to store and display data corresponding to the individual user's achievements, be accessed by visitors to the web portal, and link the web portal to the authenticating database so as to verify the individual user's achievements through the displayed data.

### BRIEF DESCRIPTION OF THE DRAWINGS

Reference will now be made to the drawings, wherein like parts are designated by like numerals, and wherein

FIG. 1 is schematic block diagram of a network including an individual user's “boast site” and an institution's “boast site” in accordance with the invention.

FIG. 2 is a schematic chart of the method and system of organizing credentials information according to the present invention.

### DETAIL DESCRIPTION OF THE INVENTION

Web sites serve different purposes. There are reliable and unreliable Web sites in most categories of Web sites. A personal Web site, which expresses the interests and lists credentials of its author, is one type of a legitimate Web site. Like any other source, the authority of the person owning the web site or web page helps determine the value of the information presented on that site. However, a visitor to the personal web page cannot easily determine whether the information on such personal web site is credible. The present invention can be more specifically described as a “Boasting Board” that provides a method and system of managing information about achievements, awards and other credentials of a member of a social network. The system allows the member to manage data, make it accessible to other members of the social network and provides a means of verifying the uploaded information by linking specific modules to educational institutions, professional organizations, military record depositories, etc.

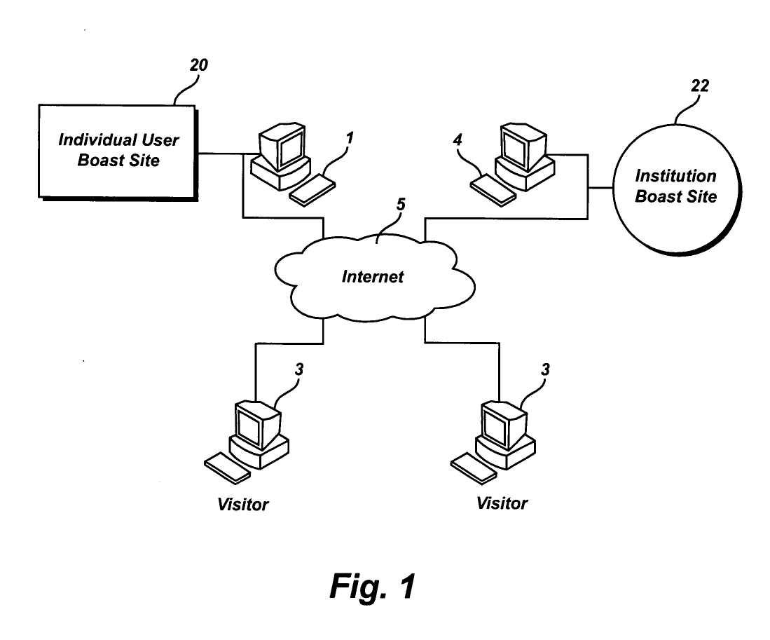

In a preferred embodiment of the present invention the users have access to a web portal, and the system assumes that an individual user has a server with a memory unit or computer 1, that visitors' to the individual user's web portal have servers with memories or computers 2 and 3, and that an institution has a server with memory or computer 4, as depicted in the schematics of FIG. 1. The servers 1-4 are connected via the Internet 5. Each computer is assumed to have internet connectivity and a certain memory allowing it to store and upload the desired information. Each computer has a memory. The individual user's computer 1 has a first memory configured to store electronic image or text data corresponding to an original data stored in a second memory of the institution computer 4. The second memory has a verifiable provenance established by the reputable institution. The visitor 2 and/or 3 have computers that can remotely access the first memory and the second memory and electronically display verification information corresponding to the provenance of the image or text data presented by the first computer and stored in the first memory and the second memory.

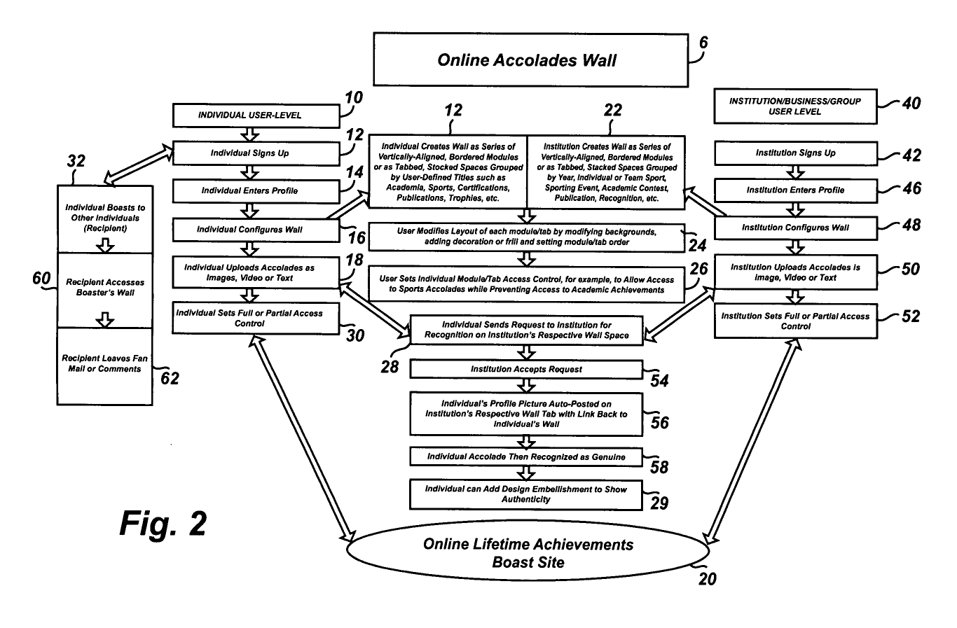

As shown in the flow chart in FIG. 2, a member of an online social network (“individual user”) 10 signs up for the service provided by the service provider 6 of the Online Accolades Wall System of the present invention, in step 12. The individual user fills out the required application form to create a unique identifiable profile in step 14, and then configures an Individual User Wall 20 (in step 16) by uploading the individual's information about the user's educational credentials, athletic awards, scientific publications, professional accomplishments and the like in step 18. The individual user 10 creates the Wall 20, in step 19 using his or her images, text, scanned documents and the like.

The individual user's page on the social network site or individual user's wall (“boast site”) 20 can be created in various configurations, such as images, videos or text. The Wall 20 is displayed on a computer screen as a series of vertically aligned, bordered modules or as tabbed, stacked spaces grouped by the individual user according to the nature of the data. The system groups the data into various categories, such as for instance Academia, Sports, Certifications, Publications, Trophies, Awards, etc. The individual user 10 can use several modules out of those offered by the system depending on the individual user's areas of expertise.

When the individual user lists an achievement that can be verified by an institution, be it a university, professional society or a sport organization, the individual user 10 offers a means for verifying the user-posted information using direct links from the individual user's wall 20 to the institutional page, where the individual user's credentials can be confirmed. This aspect of the invention will be explained in more detail below.

On the Institution side, the Institution, such as an educational, business or group 40 signs up with the provider of the service in step 42. The institution 40 fills in an application and enters its profile in step 46. Then the institution configures the Institution Wall 22 in step 48. The institution wall 22 can be configured to be visually similar to the Individual User's Wall 20, if desired. The institution wall 22 can be created as a series of vertically aligned, bordered modules or as tabbed, stacked spaces grouped by year, individual or team sport, sporting event, academic contest, publication or recognition. Of course, the institution wall 22 can be also organized in chronological order with alphabetical sub-groups.

The individual user 10 sets the individual user's module/tab access control in step 26. For instance the individual can use the system to allow access to the sports achievement data while blocking access from the individual user's wall 20 to the academic database in the institution wall 22 database. The partial or full access to the database on the institution wall 22 is performed by selection on the individual user's side in step 30.

The institution 40 also uploads images, videos or text data about its past or present members in step 50. The institution images may be coordinated with the images, videos or text data that the individual user 10 uploaded in step 18. The institution sets up control in step 52 to allow access to its wall 22 by the users of the system.

Once the individual user's wall 20 and the institution's wall 22 are set up according to the system of this invention, the individual can send a request to the institution for establishing a direct link to the institution wall 22 in step 28. Direct linking of the individual user's wall 20 and the institution wall 22 allows the individual user 10 to coordinate each module/tab in the individual user's wall 20 with the directly linked web site of the Institution's Wall 22. The layout of the page on the individual user's “boast site” can be modified in step 24 using different choice backgrounds, adding decorative graphic elements and setting the module/tab order according to the individual user's preference.

The institution 40 uploads into the second memory electronic images, videos and/or text data about its past or present members in step 50. The institution images may be coordinated with the images, videos or text data that the individual user 10 uploaded in step 18. The institution sets up controls in step 52 preventing unauthorized access to its memory and preventing any alteration of the data stored in the second memory by the individual user or visitors. The controls established by the institution allow access to the Institution's Wall 22 by the users of the system and visitors who have accessed the individual user wall 20.

After the institution receives a request 28 from the individual user 10, the institution 40 confirms that the individual user 10 has connection to the institution through academic, educational, professional or other association. The individual user's request for direct linking is accepted in step 54. Then the system allows the individual user to post the user's profile on the institution wall 22 with a link back to the individual user's wall 20 in step 56. If desired, the individual user's profile can be auto-posted in the institution wall 22.

Once the Internet linking of the walls 20 and 22 is tested the individual user 10 can initiate the linking of the individual user's wall 20 with the institution wall 22. The credentials of the individual user posted online at 32 become accessible via the Internet to one or more visitors 2 and 3. The visitor clicks the link and verifies the posted information, which is recognized as genuine by the institution wall 22 or to the individual user's wall 20. For instance, a visitor 2 to the individual user's wall 20 views the wall 22 in step 60 and needs to verify the individual user's specific credentials or affiliations. By clicking on the tab/module on the individual user’ wall 20 the visitor is allowed access to the institution wall 22 where the visitor can confirm, in step 58, that the achievement claimed by the individual user is genuine.

As an optional step 62, the system of the present invention allows the visitor to leave a fan mail, wall post or comment on the individual user's wall 20. If desired, the comments may be made accessible to other visitors or only to the individual user 10. For example, a prospective employer may leave a confidential request for further information or an offer of employment, which could be viewed only by the individual user 10.

The individual user can modify, as at 59, the individual user's wall 20 throughout the term of the contract with the service provider. The new achievements can be posted on the individual user's wall 20; new links can be established with other institutions. The individual user may be allowed by the institution to use its trademarks or symbols on the linking tabs so that the visitors can easy identify the institution linked to the “boast site” of the user 10. The software embodying the system and method of the invention can be stored in a computer-readable media, tangibly embodying program instructions, which when executed by a computer connected with networking hardware so as to allow communication with the Internet, will cause the computer to: connect to the institution web site via the Internet and execute the steps of the method described above.

The system of the present invention allows an individual user to offer a means of verifying accreditation indicia posted on the individual user's web page, including reference lists, diplomas, certificates, awards, military records, rental, credit history, publications, etc. The present invention provides an improved method and system for accessing, storing, and disseminating information about credentials of an individual user to institutions, groups, potential employers and others who would welcome the ease and convenience of having a means of verifying academic and job related credentials of the individual user. The system provides a vast improvement over the existing methods used for verifying such credentials where a potential employer has to spend countless number of hours on the phone communicating with registrars, professional organizations and other entities to request documents by mail, waiting for receipt of the documents, and ensuring that the credentials claimed by the job seeker are genuine.

The present invention achieves the goal of minimizing the time spent and the expense involved in gathering educational credentials and related documents from registrars, professional organizations and other entities by providing a system that uses sophisticated web-based communication tools to link individual user's pages with institution's pages for easy access by recruiters and employers.

A visitor to the individual user's wall can verify that the individual user who posted his credentials on the personal Web page, or wall 20 has authority, qualification and connections in the field about which she or he is providing information on the web page. The visitor is provided evidence with what organization or institution is the owner of the web page is associated; whether the list of works presented on the “boasting wall” is credible. Thus a visitor can confirm that the individual user 10 is an expert in a related field. The system and method of the present invention information therefore provide an attractive interface with easy access to the original sources of information by integrating with authentication and records systems of various institutions.

Many changes and modifications can be made in the method and system of the present invention without departing from the spirit thereof. I therefore pray that my rights to the present invention be limited only by the scope of the appended claims.

I claim:

1. A remotely-accessible computer system, comprising:
a first memory configured to store and display electronic image and/or text data;
a second memory configured to store and display an original data corresponding to the electronic image and/or text data stored in the first memory, said second memory having a verifiable provenance; and
a means for remotely verifying provenance of the electronic image and/or text data stored and displayed in the first memory and authenticated by the second memory.

2. The computer system of claim 1, wherein the electronic image and/or text data stored in the first memory corresponds to verifiable electronic image and/or text data stored in the second memory, and wherein the second memory is under control of an authenticated institution.

3. The computer system of claim 1, wherein data stored in the second memory cannot be altered by users of the first memory.

4. The computer system of claim 1, including a computer, a display controlled by the computer, and networking hardware connecting the computer to the Internet configured to receive the image and/or text data from a remote location.

5. The computer system of claim 1, wherein the electronic image and/or text data stored in the first memory and the second memory comprises predetermined accreditation indicia posted in the first memory and configured to be viewed by a remote user.

6. The computer system of claim 1, wherein said means for remotely verifying provenance of the electronic image and/or text data stored in the first memory and authenticated by the second memory comprises a hyperlink stored in the first memory and configured to link the user to the second memory.

7. A method of displaying accreditation indicia online, comprising the steps:
creating electronic image and/or text data containing accreditation indicia of an individual user;
establishing verifying database of electronic image and/or text data corresponding to the accreditation indicia of the individual user by an accredited institution;
providing electronic, displayable verification information corresponding to the provenance of at least part of the accreditation indicia of the individual user; and
displaying the image and/or text data and the verification information, to permit a user to confirm user's accreditation.

8. The method of claim 7, wherein the accreditation indicia comprises evidence of the individual user's accomplishments in a pre-selected field.

9. The method of claim 7, wherein the step of providing electronic, displayable verification information comprises a step of establishing a hyperlink to the verifying database, supplying the hyperlink to the individual user and allowing controlled access to the verifying database through the supplied hyperlink.

10. The method of claim 9, further comprising a step of allowing a third-party access to the electronic image and/or text data containing accreditation indicia of the individual user.

11. The method of 10, wherein said step of allowing third-party access comprises a step of allowing a third-party access to the verifying database through the supplied hyperlink.

12. The method of claim 7, further comprising a step of creating a personal web portal for displaying the image and/or text data corresponding to the accreditation indicia of the individual user and allowing third-party access to the web portal.

13. The method of claim 12, further comprising a step of allowing a third party to post a message on the personal web portal.

14. The method of claim 7, wherein accreditation indicia cannot be altered by the user.

15. A system for managing and disseminating accreditation credentials, comprising:
an individual user's web portal;
a first server configured to receive and store user's credentials data and to display the credentials data on the individual user's web portal;
a second server configured to store and display authenticating data corresponding to the user's credentials data, said second server allowing access to the authenticating data through a hyperlink posted on the individual user's web portal;
a third party server configured to remotely connect to the individual user's web portal and access displayed authenticating data through the hyperlink posted on the individual user's web portal.

16. The system of claim 15, wherein the credentials data is academic, professional, military and/or sport-related data.

17. The system of claim 15, wherein the second server is a server of an academic, professional, military and/or sport institution

18. The system of claim 15, wherein the individual user's web portal is a social network web site.

19. The system of claim 15, wherein authenticating data cannot be altered by the individual user.

20. The system of claim 15, wherein said first server is configured to allow third party visitors to the individual user's web portal to post a message for viewing by the individual user.

21. A social networking system of disseminating data about individual user's achievements, comprising: a computer, a display controlled by the computer, and networking hardware connecting the computer to the Internet, the computer programmed so that the social networking system: is configurable to create a web portal adapted to display data about the individual user's achievements, connect to an authenticating database adapted to store and display data corresponding to the individual user's achievements, be accessed by visitors to the web portal, and link the web portal to the authenticating database so as to verify the individual user's achievements through the displayed data.

22. The system of claim 21, wherein the individual user's achievements are in the academic, professional, sport, military and related fields.

23. The system of claim 21, wherein the authenticating database is an academic, professional, military and/or sport institution.

24. The system of claim 21, wherein the social networking system is configured to allow visitors to the web portal to post comments.

25. Computer-readable media, tangibly embodying program instructions, which when executed by a computer connected with networking hardware so as to allow communication with the Internet, will cause the computer to: create a web portal adapted to display data about the individual user's achievements, connect to an authenticating database adapted to store and display data corresponding to the individual user's achievements, be accessed by visitors to the web portal, and link the web portal to the authenticating database so as to verify the individual user's achievements in a pre-selected field through the displayed data.
